(19) United States
(12) Patent Application Publication
(10) Pub. No.: US 2004/0013302 A1
(43) Pub. Date: Jan. 22, 2004

(54) Document classification and labeling using layout graph matching

(76) Inventors: Yue Ma, Princeton Junction, NJ (US); Jinhong K. Guo, Princeton Junction, NJ (US); David Doermann, Ellicott City, MD (US); Jian Liang, College Park, MD (US)

Correspondence Address: HARNESS, DICKEY & PIERCE, P.L.C., Attorneys and Counselors, Suite 400, 5445 Corporate Drive, Troy, MI, 48098-2683, US

(21) Appl. No.: 10/293,859

(22) Filed: Nov. 13, 2002

Related U.S. Application Data
(60) Provisional application No. 60/337,073, filed on Dec. 4, 2001.

(51) Int. Cl. G06K 9/62; G06K 9/54

(52) U.S. Cl. 382/209; 382/305

(57) ABSTRACT

A document processing system for use in identifying a segmented document includes a data store of layout graph models that are classified and/or labeled. A matching module makes a determination of a match between a layout graph sample for the segmented document and a particular layout graph model. The matching module uses a correlator to generate an identified, segmented document that is classified and/or labeled based on the segmented document, the layout graph model, and the determination of a match.

### CROSS-REFERENCE TO RELATED APPLICATIONS

This application claims the benefit of U.S. Provisional Application No. 60/337,073, filed on Dec. 4, 2001. The disclosure of the above application is incorporated herein by reference.

### FIELD OF THE INVENTION

The present invention generally relates to document classification systems and methods, and particularly relates to document classification and labeling using layout graph matching.

### BACKGROUND OF THE INVENTION

There is great interest today in automatically processing large heterogeneous document collections. This interest is due in part to advances in hardware and network infrastructure that have enabled the easy capture, storage, transmission, and reproduction of large volumes of document images. There remains, however a general lack of sufficient techniques for handling the automated processing of large heterogeneous document collections.

Past attempted solutions have focused primarily on processing relatively narrow classes of documents, such as invoices, tax forms, and journal articles. Thus, these previous attempted solutions have had a restriction on the domain requiring that either the class be known or that the input images be classified. Although some desktop applications may allow interactive processing, the need for a completely automatic classification technique remains unsatisfied.

One of the ways the need for a completely automatic classification technique remains unsatisfied relates to classification at the page level, where there is a need to perform classification at a finer level. With identified title pages from a journal, for example, there is a title, author, abstract, keywords, text, and perhaps a copyright, running header, footer, and page number. Under most circumstances, it would only be necessary to extract the title, author, and abstract to build a citation database. Alternatively or additionally, applications might focus on the ability to perform complete automatic conversion and/or device dependent re-rendering. Both of these processes, page classification and logical labeling, are essential to a complete document analysis system.

Logical labeling techniques can be roughly characterized as either zone based or structure based. Zone-based techniques are taught, for example, by O. Altamura, F. Esposito, and D. Malerba, “Transforming paper documents into xml format with WISDOM++”, Journal of Document Analysis and Recognition, 2000, 3(2):175-198, and as taught by G. I. Palermo and Y. A. Dimitriadis, “Structured document labeling and rule extraction using a new recurrent fuzzy-neural system”, In Proceedings of The Fifth International Conference on Document Analysis And Recognition, 1999, pp. 181-184. Accordingly, zone based techniques classify each zone individually based on features of each zone. In contrast, structure-based techniques incorporate global constraints such as position.

Zone and structure based techniques can further be classified as either top-down decision based, bottom-up inference-based, or global optimization techniques. Top-down decision based techniques, for example, are taught in A. Dengel, R. Bleisinger, F. Fein, R. Hoch, F. Hones, and M. Malburg, “OfficeMAID—a system for office mail analysis, interpretation and delivery”, International Workshop on Document Analysis Systems, 1994, pp. 253-276. Top-down decision based techniques are further taught in M. Krishnamoorthy, G. Nagy, S. Seth, and M. Viswananthan, “Syntactic segmentation and labeling of digitized pages from technical journals”, IEEE Transactions On Pattern Analysis And Machine Intelligence, 1993, 15(7):737-747. Also, bottom-up inference-based techniques are taught in T. A. Bayer and H. Walischewski, “Experiments on extracting structural information from paper documents using syntactic pattern analysis”. In Proceedings of The Third International Conference on Document Analysis And Recognition, 1995, pp. 476-479. Bottom-up inference-based techniques are further taught in T. Hu and R. Ingold, “A mixed approach toward an efficient logical structure recognition from document images”, Electronic Publishing, 1993, 6(4):457-468. Further, global optimization techniques are often hybrids of the first two as taught in Y. Ishitani. “Model-based information extraction method tolerant of OCR errors for document images”. In Proceedings of The Sixth International Conference on Document Analysis And Recognition, 2001, pp. 908-915. Global optimization techniques are still further taught in H. Walischewske, “Learning regions of interest in postal automation”, Proceedings of The Fifth International Conference on Document Analysis And Recognition, 1999, pp. 317-340.

One past solution includes a system for page genre classification as taught in C. Shin, D. Doermann, and A. Rosenfeld, “Classification of document page images based on visual similarity of layout structures”, SPIE Conference on Document Recognition and Retrieval (VII), 2000, pp. 182-190. This system focused on separating general classes of documents, such as business letters from tax forms. The need remains, however, for a finer level of paper classification. In particular, the need remains for an ability to differentiate visually distinct documents of the same genre, such as two different instances of publication title pages in the journal class, and to further perform logical labeling of their components. The present invention fulfills the aforementioned need.

### SUMMARY OF THE INVENTION

In accordance with the present invention, a document processing system for use in identifying a segmented document includes a data store of layout graph models that are at least one of classified and/or labeled. A matching module makes a determination of a match between a layout graph sample for the segmented document and a particular layout graph model. The matching module uses a correlator to generate an identified, segmented document that is classified and/or labeled based on the segmented document, the layout graph model, and the determination of a match.

In a preferred embodiment, an integrated page classification and logical labeling method achieves simultaneous classification and logical labeling. A layout graph model is developed for each visually distinct layout based on the observation that page layouts tend to be consistent within a document class. Then, through the matching from an unknown page to a model, page classification and logical labeling are achieved simultaneously. In one aspect, the method includes representing layout by a fully connected attributed relational graph that is matched to the graph of an unknown document. In another aspect, the method includes incorporating global constraints in an integrated fashion, thereby avoiding local ambiguity at the zone level and providing robustness against noise and variation. In yet another aspect, models are automatically trained from sample documents to be labeled.

The present invention is advantageous over previous page classification systems and methods in that the layout graph matching approach is promising in both page classification and logical labeling. For example, the concept of layout graph retains important features of a page in a tractable format. Also, the search algorithm for best match is efficient and effective. Further, the automatically learned model generalizes well. Still further, when compared to zone classification methods, the global optimization approach more effectively represents global constraints. Finally, the hierarchical model base, where leaves are specific models, and non-terminal nodes are unified models, allows page classification and logical labeling to be done in a hierarchical way. Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of a document identification system performing simultaneous document labeling and classification according to the present invention;

FIG. 2 is a block diagram of layout graph models developed from segmented documents having visually distinct layouts according to the present invention;

FIG. 3 is a block diagram depicting sequential information processing according to the present invention;

FIG. 4 is a block diagram depicting a labeled layout graph model developed from four layout graph samples developed from documents of a particular class of documents; and

FIG. 5 is a flow diagram depicting a method of making and using a document identification system according to the present invention.

### DETAILED DESCRIPTION OF THE PREFERRED EMBODIMENTS

The following description of the preferred embodiment(s) is merely exemplary in nature and is in no way intended to limit the invention, its application, or uses.

By way of overview, the present invention essentially assigns labels to segmented blocks on a page, and simultaneously classifies the document. Given a segmentation result of a document page for a class of documents, the present invention generates a layout graph to describe the attributes of the segmented blocks, and of their spatial relations. From a set of such layout graphs that have been classified and labeled correctly, a model layout graph is constructed. Then, this model is matched to new unknown layout graphs. After the best match is found, the nodes of the unknown graph are labeled with the labels in the model graph, and the segmented document is thus simultaneously labeled and classified.

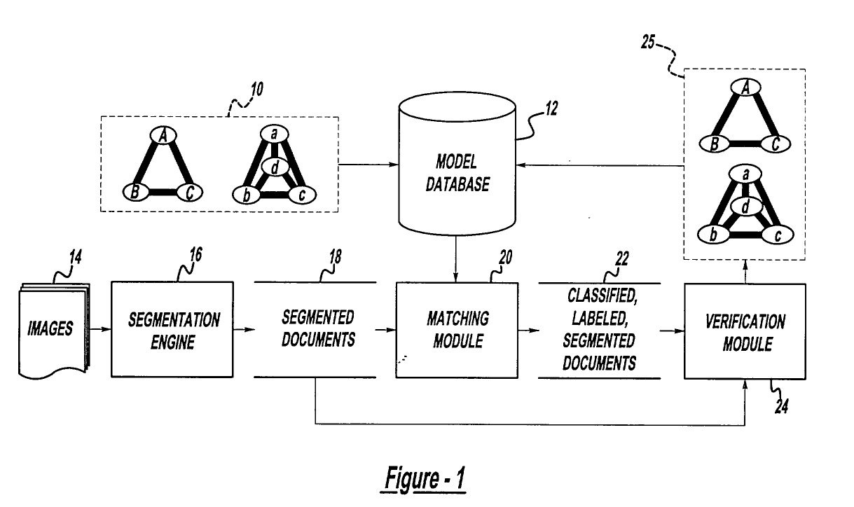

FIG. 1 shows an overview of the system framework using the layout graph models 10 that have already been developed and stored in a model data store 12. Images of documents 14, for example, are segmented using a segmentation engine 16 which preferably incorporates Optical Character Recognition (OCR). The present invention can be accomplished in part using, for example, ScanSoft's DevKit 2000 (version 10), which supports image preprocessing, segmentation and OCR, as a front-end segmentation engine. The output is a stream of characters, their rectangular position, font size and style, and mark up field indicating which characters belong to a line, and which lines belong to a zone. The segmentation text vs. non-text blocks, and the font style of each character can be unreliable. The characters or lines of one zone may have different font sizes with observable cases of lines of large font from title and lines of small font from author section grouped into one zone. In such cases, the present invention includes insertion of a step to further segment lines with different font sizes. Also, words in a line that are too far apart are separated. After these adjustments, the output from the engine is a set of zones, each consisting of a few lines, which contain a series of characters. Font sizes of all characters in one line can be averaged to give the font size of the line. Similarly, zone font size can be obtained from lines, wherein all lines in a zone have a same font size. Notably, font sizes of characters within a line may be different, but font sizes of lines in a zone are all the same; otherwise the zone would have been partitioned into two zones where two adjacent lines have different font sizes. Lines and zones may overlap with each other, but overlapping usually only occurs in tables and figures, which tend to be over-segmented by DevKit. The subsequent disclosure focuses on segmented blocks of text, but font size for segments of graph would be considered null when improved graph segmentation engines become available.

The segmentation and, optionally, OCR results 18 are matched to one or more document models in the classification and labeling process performed by matching module 20. A classified and labeled, segmented document 22 is thus generated, with document class and logical labels associated with each segment. After verification of correct identification using verification module 24, the segmentation/OCR and classification/labeling results are fed into a model-training process 25, which learns or improves the document model for that class stored in model data store 12. Learning takes place if verification module 24 reveals a need for a new model, in which case the model can be built, classified, and/or labeled either automatically and/or manually as circumstances dictate. The result 22 of segmentation, OCR, classification, and logical labeling can be used in various applications like database input, automatic conversion, publication, and/or routing. The present invention focuses on classification, labeling, and model training processes.

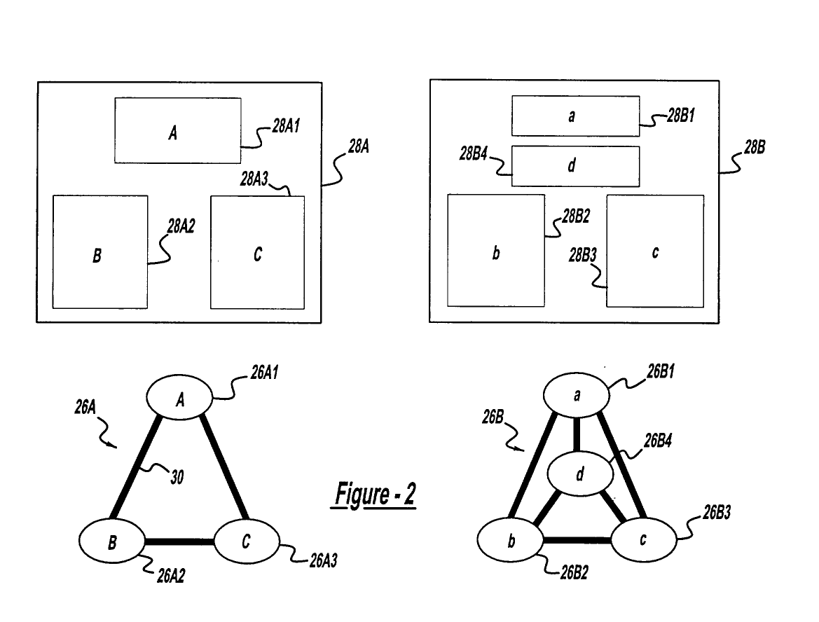

The concept of the layout graph is explored in greater detail with reference to FIG. 2. In principle, every segmentation result of a document image defines a unique layout graph sample. Thus, a layout graph sample is not unique to a document image, but a certain segmentation. It follows that when a layout graph model is generated from a set of layout graph samples, there is not a specific page segmentation corresponding to it. Thus, the model can be viewed as an “average” of all the samples. Also, when a model is generalized for more than one type of document, depending on how the generalization is defined, the model may contain nodes that never occur together in any real layout graphs.

The layout graph, 26A and 26B, is a fully connected attributed relational graph. In a layout graph sample, each node, 26A1-26A3 and 26B1-26B4, corresponds to a segmented block, 28A1-28A3 and 28B1-28B4, on an imaged document 28A and 28B. Its attributes include the position and size (the central x- and y-coordinates, width and height of the enclosing rectangle), and the average font size (if applicable). The average font size is an arithmetic average of all character's font sizes within the block.

Nodes of a layout graph model have the same attributes as those of a layout graph sample, plus the addition of an occurrence weight, and a set of weight numbers associated with positions and font size. A node can thus be described by an 11-tuple (x, y, w, h, f, o; wₓ, w_{y}, w_{w}, wₕ, w_{f}), where x, y, w, h stand for position and size, f is font size, o is occurrence weight, and w* are weights.

The occurrence weight is positively related to the possibility of the occurrence of the block. This occurrence weight is useful for a layout graph model which is a summary of a class of layout graphs. For example, in a class of title pages, suppose that half of them have page numbers on the lower right corner, while the other half have page numbers on the lower left corner, as with odd pages and even pages. Then the general model could have two different page numbers on both locations, and the possibility of each occurrence would be 50%. Further, all pages of this example have a title at the upper center position; thus the general model would have one node for the title, whose possibility of occurrence is 100%. Now the occurrence weight of the title node should be higher than those of two page number nodes indicating the fact that a title block is always there, but that neither page number is always there. This occurrence weight number is useful during the matching process.

An edge 30 between a pair of nodes 26A1 and 26A2 reflects the spatial relation between the two corresponding segmented blocks 28A1 and 28A2 in the image 28A. A block can be either above or below another, and to the left or right of it. However, it is not always precise to use the phrase “above” or “below”. For example, in FIG. 2, block 28B1 is precisely “above” block 28B2, however, it is not certain if one could say block 28B1 is “to the right of” 28B2. It is also imprecise to say block 28B1 is “partially to the right of” block 28B2 where they overlap in a horizontal direction. The present invention thus uses a more precise method for defining these edges to pinpoint the spatial inter-relation of segmented blocks.

First, the relation is divided into horizontal and vertical directions, respectively. There are two further choices for the one dimensional relation. One is to adopt a concept of relations between intervals. However since noise must be considered, so must some error tolerance be in the relations. A pointwise relation proves more natural to adapt to error tolerance. This idea includes expressing the relations between two intervals by relations among several feature points on both document segments (the left and right end, the middle point, and so on). For instance: block 28B1's left side is to the right of block 28B2's left side, as are their right sides. Also, block 28B1's right side is to the right of block 28B2's left side, while block 28B1's left side is to the left of block 28B2's right side. Furthermore, if their middle point is considered in a horizontal direction, it can be said that block 28B1's middle is to the right of block 28B2's middle. The precision of the resulting relation rises with the number of feature points chosen. Error tolerance is introduced as a threshold below which a value is deemed as zero. Thus, if the difference between their x(y) coordinates is below this threshold, two points are said to be aligned in the x(y) direction.

In the preferred embodiment, 9 pointwise relations are chosen to express the relation between two blocks. Block 28B1's position can thus be defined by its left, top, right and bottom coordinates as a=(lₐ, tₐ, rₐ, bₐ), and so can block 28B2's position as b=(l_{b}, t_{b}, r_{b}, b_{b}). If we let e denote the alignment error tolerance, then the spatial relation from a to b is defined as:

$${R}_{ab} = \{ {R}_{ab}^{l} , {R}_{ab}^{m} , {R}_{ab}^{r} , {R}_{ab}^{t} , {R}_{ab}^{b} , {R}_{ab}^{lr} , {R}_{ab}^{rl} , {R}_{ab}^{tb} , {R}_{ab}^{bt} \}$$

$$where$$

$$\begin{matrix}{R}_{ab}^{l} = R ( {l}_{a} , {l}_{b} , e ) \\ {R}_{ab}^{m} = R ( ( {l}_{a} + {r}_{a} ) , ( {l}_{b} + {r}_{b} ) , e / 2 ) \\ {R}_{ab}^{r} = R ( {r}_{a} , {r}_{b} , e ) \\ {R}_{ab}^{t} = R ( {t}_{a} , {t}_{b} , e ) \\ {R}_{ab}^{b} = R ( {b}_{a} , {b}_{b} , e ) \\ {R}_{ab}^{lr} = R ( {l}_{a} , {r}_{b} , e ) \\ {R}_{ab}^{rl} = R ( {r}_{a} , {l}_{b} , e ) \\ {R}_{ab}^{tb} = R ( {t}_{a} , {b}_{b} , e ) \\ {R}_{ab}^{bt} = R ( {b}_{a} , {t}_{b} , e )\end{matrix}$$

$$and$$

$$R ( s , t , e ) = \{ \begin{matrix}- 1 & if s < t - e \\ 1 & if s > t + e \\ 0 & otherwise\end{matrix}$$

In a layout graph model, in addition to the 9 attributes associated with an edge, there are also 9 weights indicating how important or stable these attributes are. The weights are denoted as:

$${W}_{ab} = ( {W}_{ab}^{l} , {W}_{ab}^{m} , {W}_{ab}^{w} , {W}_{ab}^{t} , {W}_{ab}^{b} , {W}_{ab}^{be} , {W}_{ab}^{wl} , {W}_{ab}^{tb} , {W}_{ab}^{bt} )$$

An edge is thus fully described by:

(a,b)_{c}=(R(a,b),w(a,b))

Note that R(b,a)=−R(a,b), while w(a,b)=w(b,a). Table 1 shows attributes of edge AB as an example:

TABLE 1

| Edge of block A | Spatial relation | Edge of block B |
|---|---|---|
| Left | To-the-right-of | Left |
| Left | To-the-left-of | Right |
| Right | To-the-right-of | Right |
| Right | To-the-left-of | Right |
| Top | Above | Top |
| Top | Above | Bottom |
| Bottom | Above | Bottome |
| Bottome | Above | Top |
| Vertical centre | To-the-left-of | Vertical centre |

In accordance with the above definitions, a layout graph G is the combination of a node set and an edge set as follows:

G=({gᵢ}_{i=1, 2 . . . ,N},{(gᵢ, gⱼ)ₑ}_{i, j=1, 2, . . . ,N})

For a layout graph model generalized over a set of samples, there might be some inconsistency. For example, the average position of title in a model graph may overlap with that of author. On the other hand, the spatial relation between them is that “title is always above author and they don't touch”. This inconsistency exists because positions and relations are independently learned in the model learning process. This inconsistency does not affect the matching result.

The optimal solution for graph matching in general is an NP problem. Practical solutions either employ branch and bound search with the help of heuristics, or non-linear optimization techniques as taught in S. Gold and A. Rangarajan, “A graduated, assignment algorithm for graph matching”, IEEE Trans. Pattern Anal. Machine Intell., 1996, 18(4):377-388.

The preferred embodiment uses an N−1 matching algorithm to find a best match between graphs that reduces the computational cost. Thus, because the search for best one-to-n match is computationally prohibitive, the match between graphs is restricted to the one-to-one case. Essentially, the algorithm involves finding the best 1-1 match, then identifying unmatched nodes and matching them independently of each other, but with reference to the best one-to-one match found in the first step.

The present invention uses a simplified version of the branch and bound search algorithm in finding the first one-to-one match. Any search path containing two or more major errors, like placing title beneath author, is quickly eliminated.

For example, suppose two graphs G and H have n and m nodes, respectively. For each node of G, either we leave it unmatched, or match it to an unmatched node of H. This node from H is then marked as “matched”. After every node of G is treated this way, a mapping is generated between G and H. Such a mapping is called a “match”.

It is easy to find the number of all possible matches to be (n+m)!. For example, in FIG. 2, two page segmentations are shown. One page is segmented into 3 blocks, while the other has 4. Two layout graphs, G and H, are built for them, respectively. Below are three example matches between G and H. There are all together (3+4)!=5,040 possible matches.

$$( \begin{matrix}ABC φ \\ abcd\end{matrix} ) ( \begin{matrix}ABC φ φ \\ φ bcad\end{matrix} ) ( \begin{matrix}ABC φ φ φ φ \\ φ φφ abcd\end{matrix} )$$

In order to define the suitability of a match, a cost of the match is computed. A minimum requirement is that a match of a graph onto itself bears zero cost. Next, it is desirable that the cost not only reveal how well the matched components of two graphs fit each other, but also include the influence of unmatched components of both. Last, we want the cost to be normalized somehow with respect to the size of the two graphs.

From the viewpoint of graph G, the match between it and H can be depicted by a set of pairs, where each pair contains a node in G and the matched node in H, or null. It can be written as

$$M ( G , H ) = \{ {( g , h ( {g}_{i} ) )}_{i = 1}^{n} \}$$

where h(gᵢ) could be one node in H, or φ. Symmetrically,

$$M ( H , G ) = {\{ ( {h}_{i} , g ( {h}_{i} ) ) \}}_{i = 1}^{m} .$$

Both h(φ) and g(φ) are undefined. And h=g⁻¹, that is, h(g(hᵢ))=hᵢ, and g(h(gᵢ))=gᵢ. So a match between G and H is uniquely determined by M (G, H) and M (H,G). It can be written as M(G, H)=(M(G, H), M(H, G)).

For each of M(G, H) and M(H, G), a cost is defined. Then the total cost is the summation of both. That is:

cₜₒₜₐₗ(M(G,H))=C₁(M(G,H))+C₁(M(H,G))

C₁(M(G, H)) is the match cost from the viewpoint of G normalized with respect to the size of G. Cost C₁ comprises contributions from both node pairs and edge pairs.

Suppose there are two nodes:

a=(x^{a},y^{a},w^{a},h^{a},f^{a},o^{a},wₓ^{a},w_{y}^{a},wₐ^{a},wₕ^{a},w_{f}^{a})

b=(x^{b},y^{b},w^{b},h^{b},f^{b},o^{b},wₓ^{b},w_{y}^{b},w_{w}^{b},wₕ^{b},w_{f}^{b})

Then, the cost of matching a to b is defined as:

cₙ(a,b)=wₓ^{a}|x^{a}−x^{b}|+w_{y}^{a}|y^{a}−y^{b}+w_{w}^{a}|w^{a}−w^{b}|wₕ^{a}|h^{a}−h^{b}|+w_{f}^{a}δ(f^{a},f^{b})

where δ(x, y)=0 if x=y, and δ(x, y)=1 otherwise. Note that the cost is unsymmetrical as cₙ(a, b)≠cₙ(b, a). The cost of matching a node to null is simply cₙ(a, φ)=o^{a} and cₙ(b, φ)=o^{b}. Both cₙ (φ, a) and cₙ(φ, b) are undefined.

An edge is defined by its attributes and associated weights. Suppose there are two edges ab and cd, where ab is a model edge and cd is an unknown edge. These edges are written as:

ab={R_{ab}, W_{ab}}

cd={R_{cd}, W_{cd}}

where

$$\begin{matrix}{R}_{ab} = \{ {R}_{ab}^{l} , {R}_{ab}^{m} , {R}_{ab}^{r} , {R}_{ab}^{t} , {R}_{ab}^{b} , {R}_{ab}^{lr} , {R}_{ab}^{rl} , {R}_{ab}^{tb} , {R}_{ab}^{bt} \} \\ {R}_{cd} = \{ {R}_{cd}^{l} , {R}_{cd}^{m} , {R}_{cd}^{r} , {R}_{cd}^{t} , {R}_{cd}^{b} , {R}_{cd}^{lr} , {R}_{cd}^{rl} , {R}_{cd}^{tb} , {R}_{cd}^{bt} \}\end{matrix}$$

are their attributes, and

$${W}_{ab} = ( {W}_{ab}^{l} , {W}_{ab}^{m} , {W}_{ab}^{r} , {W}_{ab}^{t} , {W}_{ab}^{b} , {W}_{ab}^{lr} , {W}_{ab}^{rl} , {W}_{ab}^{tb} , {W}_{ab}^{bt} )$$

are the weights of ab.

The cost of matching ab to cd is then defined as:

$${c}_{e} ( ab , cd ) = {\sum }_{k ε I}^{} {W}_{ab}^{λ} δ ( {R}_{ab}^{k} , {R}_{cd}^{k} )$$

where l={l, m, r, t, b, lr, rl, tb, bt}. If any of a, b, c, d is φ, then we define cₑ(ab, cd)=cₑ(cd, ab)=0. With the cost between node pair and edge pair defined, we define the normalized cost from G to H as:

$${C}_{1} ( M ( G , H ) ) = \frac{{\sum }_{i = 1}^{n} {c}_{n} ( {g}_{i} , h ( {g}_{i} ) )}{n} + \frac{{\sum }_{i = 1}^{n} {\sum }_{j = 1 j \neq 1}^{n} {c}_{e} ( {g}_{i} {g}_{j} , h ( {g}_{i} ) h ( {g}_{j} ) )}{n ( n - 1 )}$$

Now the cost of a match between two layout graphs are fully determined. The best match is simply the match with lowest cost.

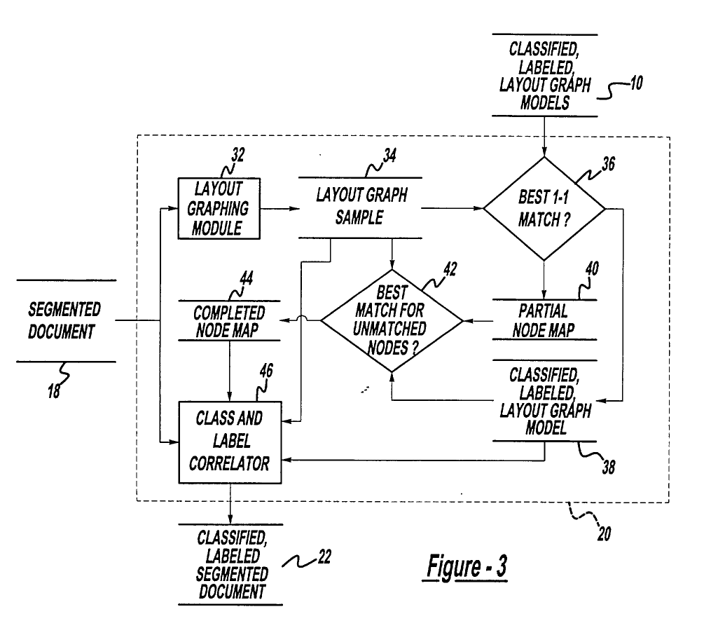

Since the present invention adopts the one-to-one match philosophy, and due to the fact that unknown samples are usually over-segmented into many more blocks than the model, many of the blocks will be left unmatched. This problem is solved using a two-step matching approach as exemplified with reference to operation of matching module 20 of FIG. 3.

Upon receipt of a segmented document, a layout graphing module 32 generates a layout graph sample 34 representing the document. A best one-to-one match is then found at 36 between the sample 34 and a particular layout graph model 38 of plurality of layout graph models 10. The result is an identification of a particular model 38 and a partial node map 40, which can be used to immediately classify and partially label the document if desired. However, according to the two step technique, a second step is performed, in which an attempt is made to substitute an unmatched node in the layout graph sample 34 for a matched node in the layout graph model 38. The substitution is carried out for each matched node, and a cost is computed for the substitution. The minimal cost leads to the “best” match for this unmatched node. Notice that this “best” match is found independent of other unmatched nodes; therefore it is optimal in a local sense, not in a global sense.

For example, for the two graphs in FIG. 2, in the first step one might get a best match: (A-a, B-b, C-c, ?-d). Next, in second step, d has three choices. Since the relation between d and b is incompatible with that between C and B, the cost will be high if d is mapped to C. Similarly B is not a good choice. The best match is A. Thus, the final “best” match is then (A-a, B-b, C-c, A-d). Thus, the second step as at 42 in FIG. 3 results in a completed node map, which can be used by class and label correlator 46 to completely and simultaneously classify and label each segment of the segmented document. This function essentially assigns a classification of the layout graph model to the segmented document based on the determination of a match, and assigns labels of labeled nodes of the layout graph model to segments of the segmented document that relate to nodes of the layout graph sample that match the labeled nodes having the labels. Overall, the final match is a one-to-n match. The major reason for adopting the two step scheme rather than a complete one-to-n match is the limit of computational power.

Though one-to-one match is much simpler than one-to-n match, its search space is still huge. However, according to the previous definition, the cost could be computed in an accumulative manner. First, one can order the nodes in one graph, say G. Then, beginning with the first g₁, one can blindly match it to either null or one of H's node, say h₁. This process increases the cost of the match. Then one can proceed to g₂ and pick another match for it, say φ, then cost is increased again. In this way, one can accumulate the total cost of the match. Next time, one could match g₁ to, for example, h₅, which drives the cost so high that it exceeds the whole cost of last graph match. In this case, there is no need to continue since the accumulated cost will only grow and never decrease. Thus, one can save a lot of time by discarding any match that has g₂ mapped to h₃. Basically it is an exhaustive search, which ensures that the best match won't be ignored. However, one can discard most non-optimum matches long before reaching the last node in G, thus speeding up the search greatly.

Compared to zone classification techniques, this approach is better at enforcing global constraints (represented by edge pair costs). Also, all constraints are considered together in the form of total cost (compared to using constraints one at a time as in a decision tree or inference machine). The advantage of such global optimization is better robustness against noise and variation. A potential disadvantage is that the optimal solution might be less understandable since intermediate steps are invisible.

The definition of document class is defined with respect to observation that subclasses of the class further constitute new classes. Thus, a layout graph model can be developed for the journal class by first developing layout graph models specific to particular journal publications and combining the results. For example, a data store of layout graph models can be organized as a tree-like structure, with non-terminating nodes corresponding to models representing classes of which child nodes correspond to models representing subclasses of the classes. Leaves, for example, can corresponding to models for particular publications, while parents of the leaves correspond to models for particular classes of publications. The parent models, thus, are likely constructed from the leaf models, or from entire or representative samples of collections of layout graph samples from which the leaf models were constructed. In turn, parents of the parents (grandparent models) are likely constructed from the parent models, or from entire and/or representative samples of collections of layout graph samples from which the parent models were constructed. This progressive construction of a hierarchical organization can be reiterated as necessary until a suitable organizational structure has been obtained for assisting in a progressive search algorithm for finding a best match. In turn, the matching process can implement a tree-searching algorithm as part of its matching process.

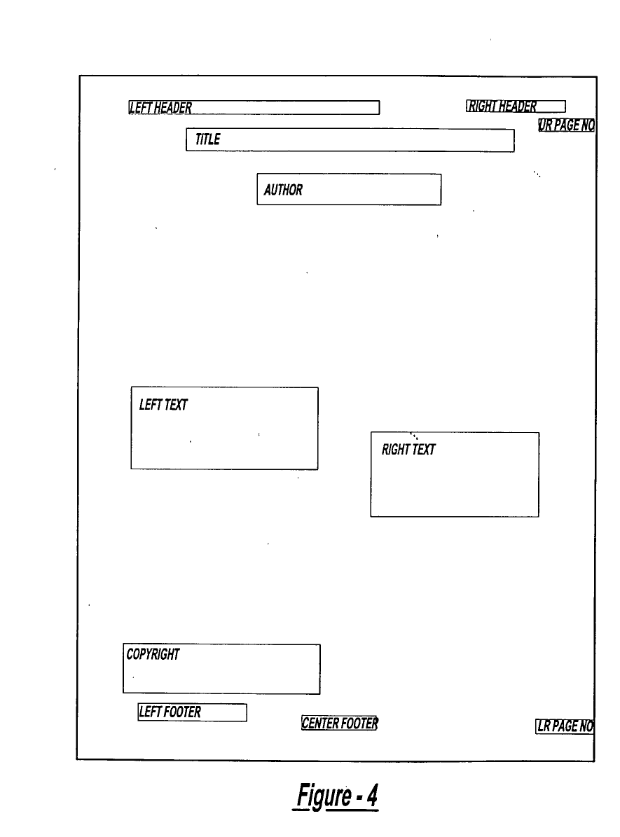

An example of a layout graph model developed from four journal publications is depicted in FIG. 4 in a segmented page format. Therein, node characteristics (relating to size) of the model are used to draw the segmented blocks, while the edge characteristics are used to configure the spatial inter-relation of the blocks on the page. The predefined labels for the blocks are also shown. Font size(s), weights, and document classification(s) are not shown, but are stored as part of the model information.

It should be noted that an identified, segmented document can take various forms, and one of these forms corresponds to a data object having four fields. The first field corresponds to a layout graph sample for the document. The second field corresponds to an array of document segments associated in memory with corresponding nodes of the layout graph sample. The third field corresponds to a layout graph model (having classifications and/or labels) that is associated in memory with the layout graph sample. The fourth field corresponds to a node map (partial or complete) mapping nodes of the model to nodes of the sample. Finally, the data object is accompanied by a correlator function for mapping classifications and/or labels to document segments, thus allowing various types of processing to occur with respect to the document segments (such as routing, storage, conversion, and/or publication) and/or the original non-segmented document.

Once labeled, the attributes of layout graph samples are fused to get the attributes of the model. For some attributes, like block position and size, the sample average is used. For others, like normalized font size, the dominant value is used. Weight factors are determined inversely proportional to the variance of the attributes in the sample set. In other words, the more stable an attribute is, the smaller its variance and the larger the weight factor. The null-cost of a model node is learned in a similar way; for example, the more often a node appears in the sample set, the higher its null-cost will be.

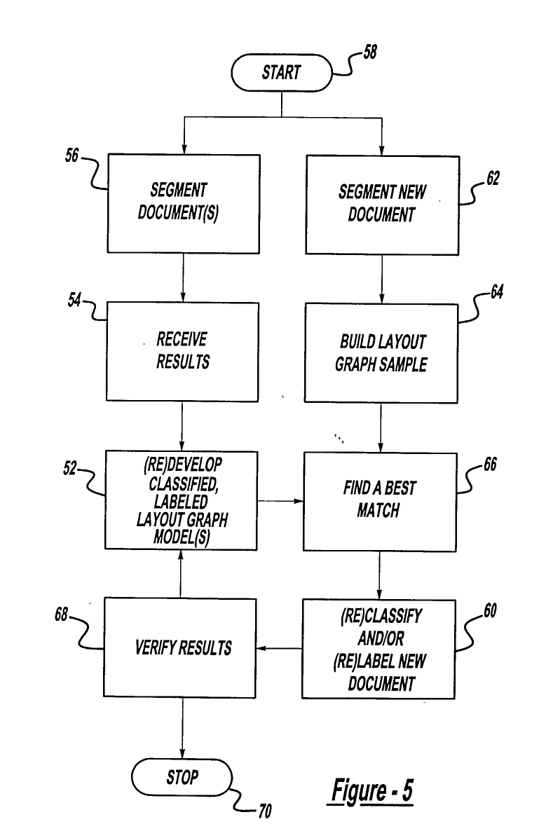

A method of making and using a document identification system according to the present invention is shown in FIG. 5. Therein, the problem of model acquisition is encountered. Model acquisition is a problem particularly addressed by the present invention in a number of ways according to various circumstances and preferences. According to the design of the present invention, it is not overly difficult to write a model completely manually at step 52 based on estimates from observations at step 54 of document segmentation at step 56. It is more desirable, however, to learn a model automatically from a set of sample layout graphs with correct logical labels.

The method of the present invention thus begins at 58 and proceeds to steps 56, 54, and 52, wherein documents are segmented, segments are received, preferably classified, labeled and converted to classified, labeled, layout graph samples, and used to develop classified, labeled layout graph models. New documents can then be identified at step 60 by segmenting them at step 60, building layout graph samples from the segmentations at step 64, and matching the samples to the developed models at 66. If desired, results can be verified at step 68 and used to improve the models stored in memory. The method ends at 70.

The description of the invention is merely exemplary in nature and, thus, variations that do not depart from the gist of the invention are intended to be within the scope of the invention. It should be readily understood that documents and/or document segments can be processed in various ways based on the understanding gained by identification of the document and/or segment according to the present invention. Thus, a segmented document can be pre-classified and pre-labeled, for example, prior to processing by the present invention, so that additional or new labels or classifications can be generated for documents and/or document segments. This process can also be restricted to the task of classifying documents and/or segments, or simply labeling documents and or segments. Still further, it should be readily understood that it is not necessary to actually assign a label or class to a segmented document or corresponding layout graph sample to accomplish document identification; in particular, knowledge of a correspondence between a label and/or class and a document and/or document segment, when combined with a process or function for acting on that knowledge, constitutes generation of a labeled and/or classified document for at least a time period during which the function or process perceives the document as classified and/or labeled. The particular applications of the system and method of the present invention may, thus, depend on progressive availability of technology, changes in related practices, and/or shifting market forces. Such variations are not to be regarded as a departure from the spirit and scope of the invention.

What is claimed is:

1. A document processing system for use in identifying a segmented document, comprising:
a data store of layout graph models that are at least one of classified and labeled;
a matching module operable to make a determination of a match between a layout graph sample for the segmented document and a particular layout graph model of said data store,
wherein said matching module has a correlator generating an identified, segmented document that is at least one of classified and labeled based on the segmented document, the layout graph model, and the determination of a match.

2. The system of claim 1, wherein said matching module is operable to generate a node map useful for matching nodes of the particular layout graph model to nodes of the layout graph sample.

3. The system of claim 1, wherein said correlator is operable to assign labels of labeled nodes of the layout graph model to segments of the segmented document, wherein the segments relate to nodes of the layout graph sample that match the labeled nodes having the labels.

4. The system of claim 1, wherein said correlator is operable to assign a classification of the layout graph model to the segmented document based on the determination of a match.

5. The system of claim 1, further comprising a document segmentation engine operable to segment a document, thereby generating the segmented document.

6. The system of claim 1, further comprising a layout graphing module operable to build the layout graph sample based on the segmented document.

7. The system of claim 1, further comprising a verification module operable to perform an evaluation relating to accuracy of at least one of classification and labeling of the identified, segmented document, and to improve at least one layout graph model of said data store based on the evaluation.

8. The system of claim 1, wherein the layout graph models are comprised of nodes and edges, wherein the nodes represent document segments relating to a class of documents, and the edges are based on observed spatial inter-relation of the document segments.

9. The system of claim 1, wherein said data store of layout graph models has a hierarchical organization with layout graph models representing document subclasses that are subordinate to a specific document class related to a specific layout graph model representing the specific document class in a subordinate fashion, and wherein said matching module is operable to successively attempt matches between the layout graph sample and multiple layout graph models based on the hierarchical organization.

10. A method of classifying and labeling a segmented document, comprising:
receiving a layout graph sample for the segmented document;
making a determination of a match between the layout graph sample and a layout graph model that is at least one of classified and labeled; and
generating an identified, segmented document that is at least one of classified and labeled based on the segmented document, the layout graph model, and the determination of a match.

11. The method of claim 10, wherein said segmented document corresponds to an unclassified, unlabeled, segmented document, and said receiving a layout graph sample corresponds to receiving an unclassified, unlabeled layout graph sample.

12. The method of claim 10, wherein said generating an identified, segmented document includes:
(a) assigning a classification of the layout graph model to the segmented document based on the determination of a match; and
(b) assigning labels of labeled nodes of the layout graph model to segments of the segmented document, wherein the segments relate to nodes of the layout graph sample that match the labeled nodes having the labels.

13. The method of claim 10, wherein the segmented document corresponds to an unlabeled, segmented document.

14. The method of claim 10, wherein the segmented document is at least one of pre-classified and pre-labeled, and wherein said generating a classified, labeled, segmented document at least one of re-classifies, re-labels, further classifies, and further labels the segmented document.

15. The method of claim 10, wherein said generating an identified, segmented document includes assigning labels of labeled nodes of the labeled, layout graph model to segments of the segmented document, wherein the segments relate to nodes of the layout graph sample that match the labeled nodes having the labels.

16. The method of claim 10, wherein said generating a classified, labeled, segmented document includes assigning a classification of the layout graph model to the segmented document based on the determination of a match.

17. The method of claim 10, comprising segmenting a document, thereby generating a segmented document.

18. The method of claim 10, wherein said receiving a layout graph sample includes building the layout graph sample based on the segmented document.

19. The method of claim 10, wherein said making a determination of a match between the layout graph sample and a layout graph model includes:
(a) accessing a data store of layout graph models having a hierarchical organization, wherein with layout graph models representing document subclasses that are subordinate to a specific document class related to a specific layout graph model representing the specific document class in a subordinate fashion; and
(b) successively attempting matches between the layout graph sample and multiple layout graph models based on the hierarchical organization.

20. A method of building a labeled, layout graph model for a class of documents, comprising:
receiving segmentation results of at least one segmentation of at least one document of the class of documents;
instantiating nodes to represent document segments of a page for the class of documents based on the segmentation results, wherein the nodes store information identifying characteristics of the represented document segments; and
instantiating edges relating nodes to one another based on the segmentation results, wherein the edges store information identifying spatial inter-relation of the document segments represented by the nodes.

21. The method of claim 20, comprising labeling the nodes based on predefined categories for content of corresponding document segments for the class of documents.

22. The method of claim 21, further comprising:
using the layout graph model to accomplish assignment of labels to new document segments of a new segmented document;
making a verification of assignment of labels to the new document segments; and
improving the labeled, layout graph model based on the verification of assignment of labels.

23. The method of claim 20, comprising classifying the layout graph model based on the class of documents.

24. The method of claim 20, further comprising:
using the layout graph model to perform a classification associating a new, segmented document with the class of documents;
making a verification of the classification of the new, segmented document; and
improving the layout graph model based on the verification of the classification.

25. The method of claim 20, wherein said receiving segmentation results includes segmenting at least one document of the class of documents, thereby generating the segmentation results.

26. The method of claim 20, wherein said receiving segmentation results includes observing segmentation results of at least one segmentation of at least one document of the class of documents.

27. A method of making a match between layout graph models for use with classifying and labeling documents, comprising:
receiving a layout graph sample;
comparing the layout graph sample to at least one layout graph model that is at least one of classified and labeled; and
finding a best match between the layout graph sample and a particular layout graph model.

28. The method of claim 27, wherein said finding a best match comprises:
making a best one-to-one match between the layout graph sample and the particular layout graph model;
identifying unmatched nodes; and
matching the unmatched nodes independently of one another but with reference to the best one-to-one match.

29. The method of claim 27, wherein said making a best match includes mapping nodes from the layout graph sample to nodes of the layout graph model.

30. The method of claim 29, wherein said making a best match includes computing a cost for a pair of mapped nodes, wherein the cost is defined as a sum of differences between corresponding node attributes, wherein the sum is weighed by weight factors of a node of the layout graph model, wherein the node is a member of the pair of mapped nodes.

31. The method of claim 29, wherein said making a best match includes computing a cost for a pair of mapped edges, wherein the cost is defined as a sum of differences between corresponding edge attributes, wherein the sum is weighed by weight factors of an edge of the layout graph model, wherein the edge is a member of the pair of mapped edges.

32. The method of claim 29, wherein said making a best match includes computing a sum of node pair costs and edge pair costs, wherein a mapping of minimal cost is defined as the best match.

33. The method of claim 29, wherein said making a determination of a match between the layout graph sample and a layout graph model includes:
(a) accessing a data store of layout graph models having a hierarchical organization, wherein with layout graph models representing document subclasses that are subordinate to a specific document class related to a specific layout graph model representing the specific document class in a subordinate fashion; and
(b) successively attempting matches between the layout graph sample and multiple layout graph models based on the hierarchical organization.
